(19) United States
(12) Patent Application Publication
(10) Pub. No.: US 2013/0276719 A1
(43) Pub. Date: Oct. 24, 2013

(54) Animal Coat System

(71) Applicant: Carl Bart Ferrando, New York, NY (US)

(72) Inventor: Carl Bart Ferrando, New York, NY (US)

(21) Appl. No.: 13/868,177

(22) Filed: Apr. 23, 2013

Related U.S. Application Data
(60) Provisional application No. 61/637,151, filed on Apr. 23, 2012.

(51) Int. Cl. A01K 13/00

(52) U.S. Cl. CPC A01K 13/006
USPC 119/850

(57) ABSTRACT

The animal coat system comprises a two layer coat system for small animals or dogs. The bottom (base) layer provides warmth and also functions as a harness for the animal. Velcro type fasteners secure the base layer in place on the animal at several locations. The base layer has one or more D-rings allowing a leash to be attached. An upper layer attaches to the base layer at several points using Velcro, snap, or other fasteners. The upper layer has a keyhole opening so that the D-ring on the base layer can pass through to accommodate a leash. The upper layer is available in a variety of fabric types for providing extra warmth, weather protection, or fashion. The base layer can be used without the upper layer, but the upper layer cannot be used without the base layer.

### CROSS REFERENCE TO RELATED APPLICATION(S)

This application claims the benefit of U.S. provisional application No. 61/637,151, filed Apr. 23, 2012, which is incorporated by reference as if fully set forth.

### FIELD OF INVENTION

This invention relates to protective garments for animals or dogs, and in particular to a dual layered animal coat system.

### BACKGROUND

Coats or other garments for small animals, dogs, or pets may serve a number of different functions, such as providing warmth, providing protection from rain and snow, and providing a fashionable appearance for the pet. Animal garments may employ a variety of fabrics or materials dependent upon the specific functionality provided by the animal coat.

At times an animal or pet owner may seek to customize a animal's coat to provide warmth and/or rain and snow protection in response to specific weather conditions. Or the pet owner may seek to customize a pet's coat for a specific outing where the pet will be taken. In addition, an animal coat which can also serve as a comfortable, adjustable harness, without the stress caused by a collar on the animal's neck, would offer significant utility to the animal owner. The present invention, a versatile two layer animal coat system with an integrated harness, accomplishes these objectives.

### SUMMARY

The present invention comprises a versatile multi-layer animal coat system which can be customized for a variety of weather conditions and animal needs, and which can also serve as an adjustable harness. The bottom (base) layer provides warmth and also functions as a harness for the animal or dog. An optionally used upper layer provides additional warmth, weather protection, or fashion as needed. A Velcro type fastener on the front panel of the base layer wraps around the chest and underneath the animal's neck to secure the base layer in place. One or more D-rings on the base layer allow the animal owner to attach a leash to the base layer.

One or more lower panels extend from the base layer and wrap around the body of the animal between the front and back legs, and thereby secure the base layer in place. Velcro fasteners on the lower panels allow the width of the base layer to be adjustable. Velcro fasteners, snap fasteners, or other types of suitable fasteners on the inner surface of the upper layer of the coat system attach to matching fasteners on the outer surface of the base layer, thereby securing the outer layer to the base layer. The base layer can be used without the upper layer, but the upper layer cannot be used without the base layer.

The upper layer has one or more keyhole openings proximate to its back so that D-rings on the base layer can pass through the upper layer to accommodate a leash, so that the base layer can function as a harness. The upper layer is available in a variety of fabric types for purposes of providing extra warmth, rain protection, or fashion. The upper layer also has a collar design for style only.

Other features and advantages of the present invention will become apparent from the following more detailed description, taken in conjunction with the accompanying drawings, which illustrate, by way of example, the principles of the invention.

### BRIEF DESCRIPTION OF THE DRAWING(S)

FIG. 1 is a left side view of an animal coat system with snap attachments;

FIG. 2 is a left side view of an animal coat system base layer with snap attachments;

FIG. 3 is a left side view of an animal coat system upper layer with snap attachments;

FIG. 4 is a left side view of a complete animal coat system with Velcro attachment;

FIG. 5 is a left side view of an animal coat system base layer with Velcro attachment;

FIG. 6 is a left side view of an animal coat system upper layer with Velcro attachments;

FIG. 7 is an enlarged view of a Velcro attachment of an animal coat system.

FIG. 8 is a top view of a base layer of an animal coat system.

FIG. 9 is a top view of an upper layer of an animal coat system.

### DETAILED DESCRIPTION OF ILLUSTRATIVE EMBODIMENT(S)

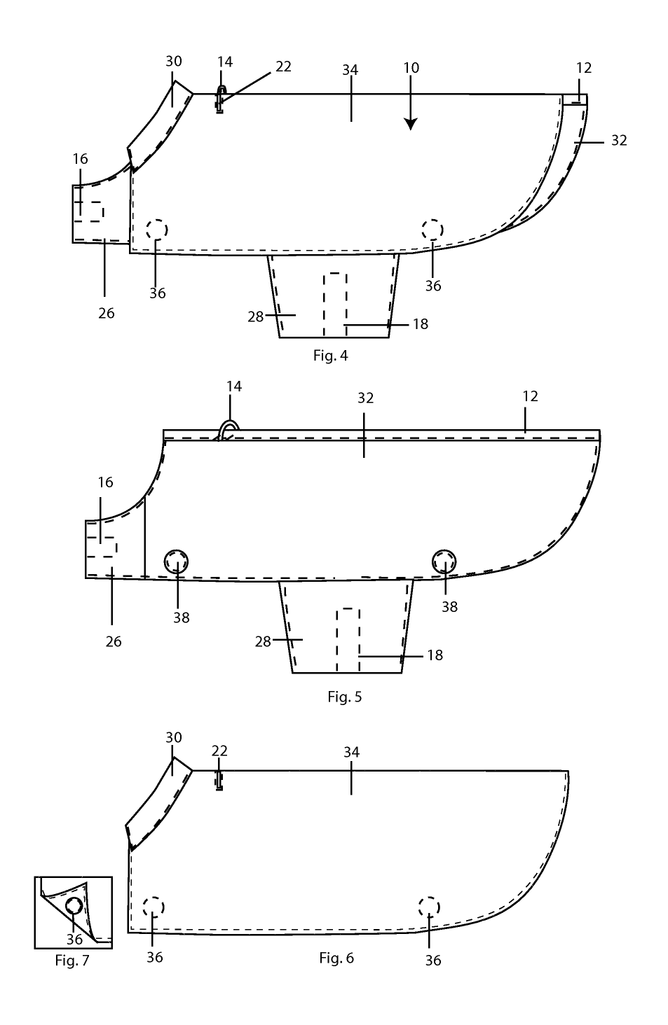

Referring to FIGS. 1 and 4, the complete animal coat system 10 is illustrated. The animal coat system 10 comprises a layered coat system for small animals or dogs which permits the animal owner the flexibility of customizing a animal coat for specific needs.

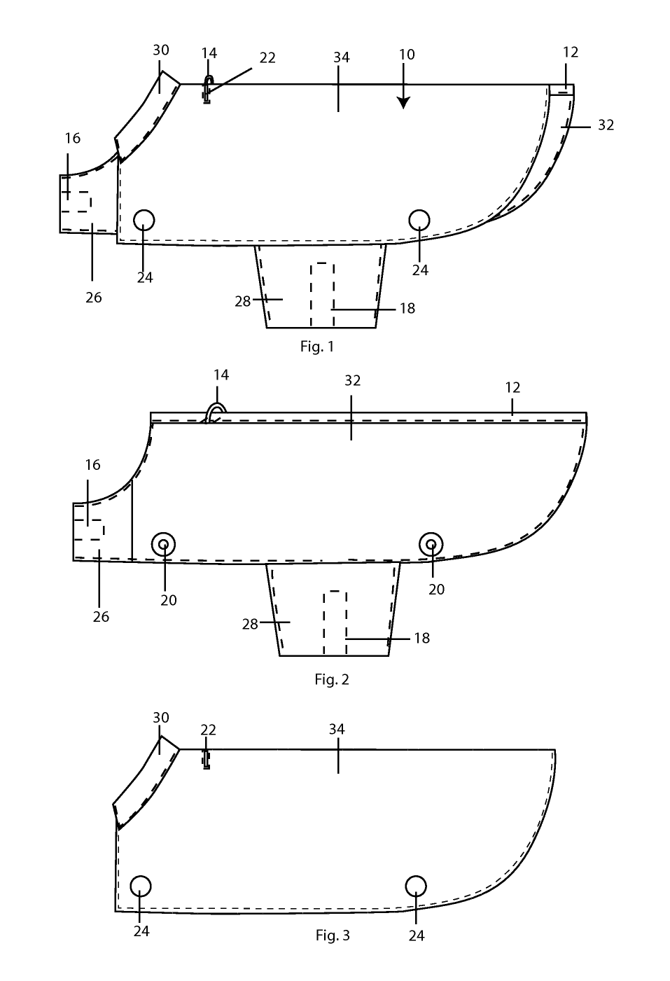

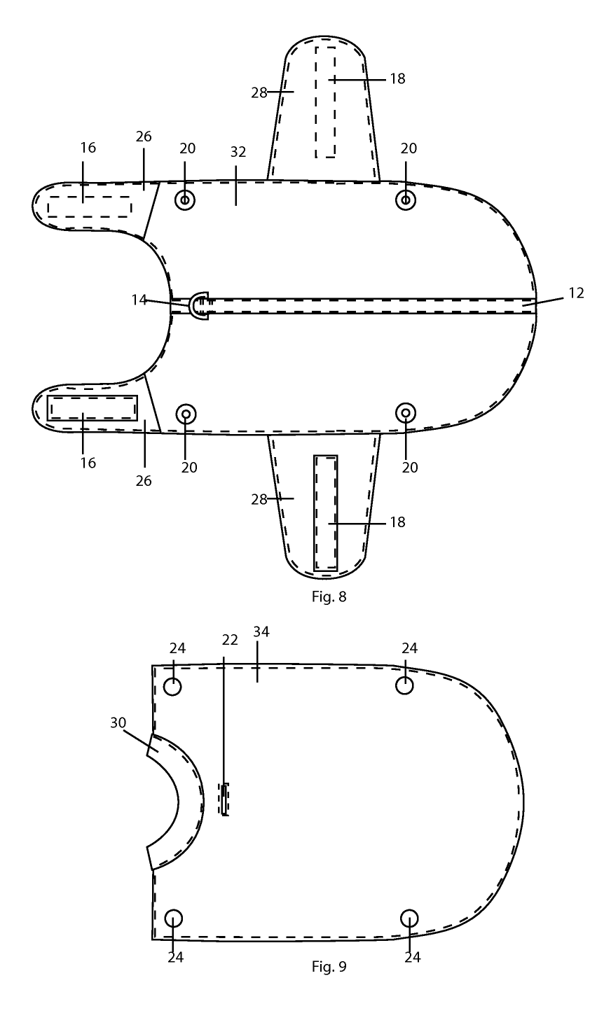

Referring to FIGS. 2, 5, and 8, the base (bottom) layer 32 is illustrated. In FIG. 8 a top view of the base layer 32 is shown spread out flat. The base layer 32 provides warmth and/or protection from the elements, and also functions as a harness for the animal or dog. The base layer 32 is an elongated integral piece of material extending laterally along the animal's trunk. The base layer 32 is secured over the back of the animal and wraps around the neck and body of the animal.

Elongated front panels 26, with Velcro type fasteners 16 at their distal ends, project laterally from the front of the base layer 32. In FIGS. 1, 2, 4 & 5 the ends of the front panels 26 have been folded over and are not visible in the figures. The front panels 26 of the base layer 32 are adjustable and wrap around and underneath the animal's neck or body to secure the base layer 32 in place in the front of the animal, using the Velcro type fasteners 16. Elongated lower panels 28 extend downwardly from the lateral edges of the base layer 32. In FIGS. 1, 2, 4 & 5 the ends of the lower panels 28 have been folded over and are not visible in the figures. The lower panels 28 wrap around the body of the animal between the front and back legs, thereby securing the base layer 32 in place on the body of the animal. Velcro type fasteners 18 on the lower panels 28 of the base layer 32 allow adjustment of the circumference of the base layer 32 so as to secure the base layer 32 on the animal.

The base layer 32 includes one or more D-rings 14 near the animal's back and/or sides, allowing the animal owner to attach a leash to the animal. The base layer 32 thereby functions as an animal harness effectively controlling the animal without straining the animal's neck. Twill tape 12 or other suitable methods known in the art are utilized to attach the D-rings 14 to the base layer 32.

In FIG. 9 a top view of the upper layer 34 is shown spread out flat. Referring to FIGS. 1, 3, 4, 6, and 9, an optionally used upper layer 34 provides additional warmth, weather protection, or fashion as needed. The upper layer 34 is an elongated integral piece of material that is secured on the animal by attaching it on top of the base layer 32. The upper layer 34 covers the back and sides of the animal, and in some embodiments covers part of the animal's neck. A collar section 30, utilized for style only, extends partially along the front of the upper layer 34. The base layer 32 can be used independently without the upper layer 34. The upper layer 34 cannot be used independently without the base layer 32.

Referring now to FIGS. 1-3 and 9, in one embodiment of the invention, a plurality of female snap mechanisms 24 fixed underneath or through the upper layer 34 of the coat system 10 securely attach the upper layer 34 to a plurality of male snap mechanisms 20 fixed on the outer surface of the base layer 32. The upper layer 34 includes one or more keyhole openings 22 proximate to its back allowing the D-rings 14 on the base layer 32 to protrude through the upper layer 34 and accommodate a leash.

Other embodiments of the invention 10 may utilize other suitable methods known in the art to securely attach the upper layer 34 to the base layer 32, including magnetic fasteners or Velcro type fasteners. For example, in FIGS. 4-6, a plurality of Velcro type fasteners 36, 38 could be used to securely attach the upper layer 34 to the base layer 32. In such an embodiment a plurality of male Velcro fasteners 36 fixed on the inner surface of the upper layer 34 would attach to a plurality of female Velcro fasteners 36 fixed on the outer surface of the base layer 32.

FIG. 7 illustrates a detailed view of a Velcro type fastener 36 fixed on the inner surface of the upper layer 34.

The invention 10 described herein may be commonly utilized with dogs, but may also be utilized with a variety of four-legged animals and pets including, but not limited to rabbits, ferrets, cats, and the like. The invention 10 may be provided in a variety of sizes to accommodate various size animals.

In some embodiments of the invention 10, the base layer 32 may be comprised of polar fleece, canvas with a nylon or woven lining, or other sturdy materials suitable for the environmental conditions. The upper layer 34 is available in a variety of fabric types for purposes of providing additional protection from environmental conditions, including additional warmth, or additional rain, snow, or weather protection. The upper layer 34 may also serve to provide fashion or enhanced appearance. In some embodiments of the invention 10, the upper layer 34 may be comprised of patent polyurethane in a variety of textured or patterned finishes. In other embodiments the upper layer 34 may be comprised of canvas, nylon, or other suitable materials, depending on the required functionality of the upper layer.

While embodiments of the invention 10 have been described in detail above, the invention 10 is not limited to the specific embodiments described above, which should be considered as merely exemplary. Further variations, modifications, extensions, or equivalents of the invention 10 may be developed without departing from the scope of the invention 10. Therefore it is intended that the invention 10 not be limited to the particular embodiments disclosed as the best mode contemplated for carrying out this invention, but that the invention 10 will include all the embodiments falling within the scope of the appended claims.

What is claimed is:

1. A garment system for four-legged animals, comprising:
a first layer of flexible material configured to substantially cover the trunk of an animal;
a second layer of flexible material configured to substantially cover said first layer;
an animal harness integrated into said first layer;
a plurality of separable fasteners configured to attach said second layer to said first layer;
one or more leash attachment points fixed onto said first layer.

2. The garment system of claim 1, wherein said separable fasteners are comprised of male and female snap mechanisms.

3. The garment system of claim 1, wherein said separable fasteners are comprised of Velcro type mechanisms.

4. The garment system of claim 1, wherein said separable fasteners are comprised of magnetic fasteners.

5. The garment system of claim 1, wherein said leash attachment points are comprised of D-rings.

6. The garment system of claim 1, further comprising elongated panels extending laterally from the front edge of said first layer, and configured to wrap securely around an animal's neck.

7. The garment system of claim 1, further comprising elongated panels extending downwardly from the bottom edges of said first layer, and configured to wrap securely around an animal's trunk.

8. The garment system of claim 1, wherein said first layer and said second layer are comprised of materials with weatherproof and heat conserving properties.

9. The garment system of claim 1, wherein the materials of said first layer are selected from the group consisting of polar fleece, canvas with a nylon lining, and canvas with a woven lining.

10. The garment system of claim 1, wherein said second layer is comprised of materials with visually enhanced properties.

11. The garment system of claim 1, wherein the materials of said second layer are selected from the group consisting of textured polyurethane materials, patterned polyurethane materials, canvas and nylon.

12. A garment system for four-legged animals, comprising:
a first layer of flexible, weatherproof material configured to substantially cover the trunk of an animal;
a second layer of visually enhanced, flexible material configured to substantially cover said first layer;
a plurality of separable snap mechanisms configured to attach said second layer to said first layer;
one or more D-rings fixed onto said first layer and configured as an animal harness;
a plurality of elongated panels extending laterally from the front edge of said first layer, and configured to wrap securely around an animal's neck;
a plurality of elongated panels extending downwardly from the bottom edges of said first layer, and configured to wrap securely around an animal's trunk.
